(19) United States
(12) Patent Application Publication
(10) Pub. No.: US 2022/0417986 A1
(43) Pub. Date: Dec. 29, 2022

(54) CHANNEL ESTIMATION USING WI-FI MANAGEMENT AND CONTROL PACKETS

(71) Applicant: Intel Corporation, Santa Clara, CA (US)

(72) Inventor: Yair BARASH, Tivon (IL)

(21) Appl. No.: 17/355,198

(22) Filed: Jun. 23, 2021

(51) Int. Cl. H04W 74/08; H04B 7/06

(52) U.S. Cl. CPC H04W 74/0808; H04B 7/0626; H04L 25/0202

(57) ABSTRACT

An apparatus of a Wi-Fi station (STA), the apparatus including a radio frequency (RF) interface, and one or more processors coupled to the RF interface configured to send a request frame to a transmitting STA; receive a response frame from the transmitting STA in response to the request frame; and determine channel state information (CSI) based on the response frame.

### TECHNICAL FIELD

Various aspects relate generally to methods and systems for aiding Wi-Fi channel estimation by triggering Wi-Fi control packets.

### BACKGROUND

Wireless networks often use 802.11 technology for channel estimation. During digital signal processing (DSP), a Wi-Fi device may evaluate a specific channel during reception of Wi-Fi network traffic. The Wi-Fi device may determine channel state information (CSI) as part of DSP. The CSI may be sent to machine learning (ML) algorithms of a Wi-Fi sensing application.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various aspects of the invention are described with reference to the following drawings, in which:

FIG. 1 shows an exemplary wireless communication channel network.

FIG. 2 shows an exemplary wireless communication device.

FIG. 3 shows an exemplary Wi-Fi sensing system including multiple stations (STAs).

FIG. 4 shows an exemplary system for channel estimation.

FIG. 5 shows an exemplary system for channel estimation.

FIG. 6 shows an exemplary system for channel estimation.

FIG. 7 shows an exemplary system for channel estimation.

FIG. 8 shows an exemplary method of performing channel estimation using control or management packets.

### DESCRIPTION

The following detailed description refers to the accompanying drawings that show, by way of illustration, specific details and aspects in which the invention may be practiced.

The word “exemplary” is used herein to mean “serving as an example, instance, or illustration.” The words “plurality” and “multiple” in the description and claims refer to a quantity greater than one. The terms “group,” “set”, “sequence,” and the like refer to a quantity equal to or greater than one. Any term expressed in plural form that does not expressly state “plurality” or “multiple” similarly refers to a quantity equal to or greater than one. The term “lesser subset” refers to a subset of a set that contains less than all elements of the set. Any vector and/or matrix notation utilized herein is exemplary in nature and is employed for purposes of explanation. Aspects of this disclosure described with vector and/or matrix notation are not limited to being implemented with vectors and/or matrices and the associated processes and computations may be performed in an equivalent manner with sets or sequences of data or other information.

As used herein, “memory” is understood as a non-transitory computer-readable medium in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit”, “receive”, “communicate”, and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers.

The term “station” or “STA” as utilized herein refers to a network device that is capable of using WLAN/Wi-Fi technology (e.g., according to any IEEE 802.11 standard). “STA” can include mobile or immobile wireless communication devices, including Access Points (APs), User Equipment (UEs), smart televisions, tablets, laptops, personal computers, wearables, multimedia playback and other handheld or body-mounted electronic devices, consumer/home/office/commercial appliances, vehicles, and any other electronic device capable of Wi-Fi communications.

The term “W-Fi sensing” (also referred to as “wireless sensing” or “WLAN sensing”) may refer to a usage of wireless technology to detect changes in an environment. For example, WLAN sensing is the use of IEEE 802.11 technology to enable WLANs and electronic devices with WLAN capability to obtain channel measurements that characterize the environment in which they are located, thus gaining spatial and contextual awareness of their surroundings, and enable applications such as presence and proximity detection, device-free positioning, and gesture classification, among many others. Wi-Fi sensing applications may support in both 2.4/5/6 GHz and 60 GHz.

The term “model” as used herein may be understood as any kind of algorithm, which provides output data from input data. For example, an algorithm generating or calculating output data from input data.

Some aspects may be used in conjunction with devices and/or networks operating in accordance with existing IEEE 802.11 standards. For example, IEEE 802.11-2016 and IEEE 802.11az, and/or future versions and/or derivatives thereof. Some aspects may be used in conjunction with a WLAN, e.g., a WiFi network or any other suitable wireless communication network, for example, a wireless area network, a “piconet”, a WPAN, a WVAN for example.

Additionally, devices and/or networks operating in accordance with existing technology and/or protocols, e.g., 3rd Generation Partnership Project (3GPP), 3GPP Long Term Evolution (LTE), WFA Peer-to-Peer (P2P) specifications (WiFi P2P technical specification, version 1.7, Jul. 6, 2016), Radio Frequency (RF), Infrared (IR), Frequency-Division Multiplexing (FDM), Orthogonal FDM (OFDM), Orthogonal Frequency-Division Multiple Access (OFDMA), Time-Division Multiplexing (TDM), Time-Division Multiple Access (TDMA), Multi-User MIMO (MU-MIMO), Spatial Division Multiple Access (SDMA), Extended TDMA (ETDMA), General Packet Radio Service (GPRS), Extended GPRS, Code-Division Multiple Access (CDMA), Wideband CDMA (WCDMA), CDMA 2000, singlecarrier CDMA, multi-carrier CDMA, Multi-Carrier Modulation (MCM), Discrete Multi-Tone (DMT), Bluetooth®, Global Positioning System (GPS), Global Navigation Satellite System (GNSS), Wi-Fi, Wi-Max, ZigBee™, Ultra-Wideband (UWB), Global System for Mobile communication (GSM), 2G, 2.5G, 3G, 3.5G, 4G, Fifth Generation (5G), or Sixth Generation (6G) mobile networks, 3GPP, Long Term Evolution (LTE), LTE Advanced, Enhanced Data rates for GSM Evolution (EDGE), and/or future versions and/or derivatives thereof, may be used in conjunction with some aspects.

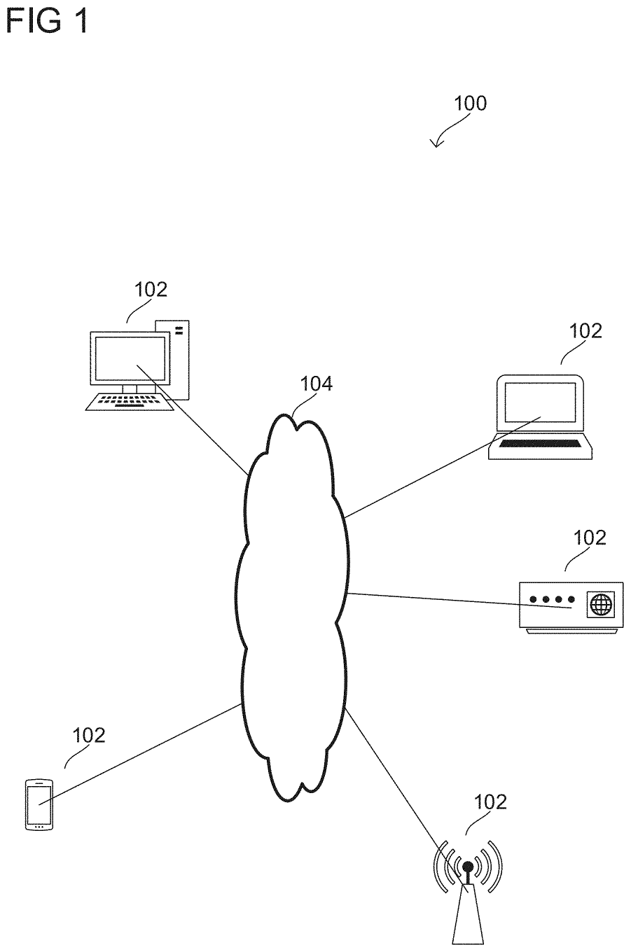

FIG. 1 depicts an exemplary network for wireless communication according to some aspects. Wireless communication network 100, such as a Wi-Fi network, may include one or more wireless communication devices 102 communicating via wireless medium 104. Wireless communication device 102 may be capable of communicating content, data, information and/or signals via a wireless medium 104. Devices 102 may operate as, and/or perform the functionality of one or more Wi-Fi STAs.

Wireless medium 104 may include a radio channel, cellular channel, GNSS channel, UWB channel, Global Positioning System GPS channel, RF channel, Wi-Fi channel, among others.

Wireless communication medium 104 may include a 2.4 GHz frequency band, 5 GHz frequency band, millimeterWave (mmWave) frequency band, 60 GHz frequency band, Sub1 GHz (S1G) band, and/or one or more other wireless communication frequency bands.

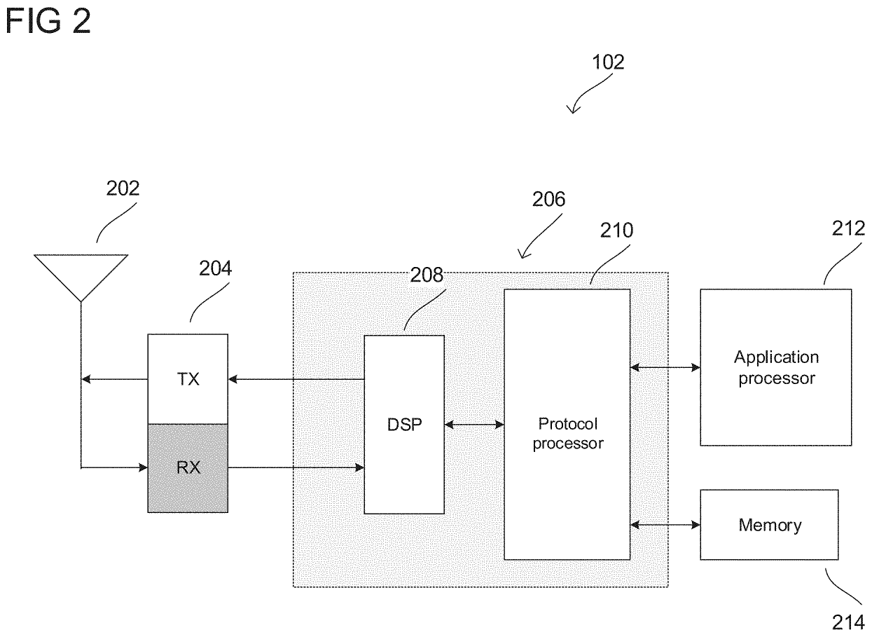

FIG. 2 shows an internal configuration of wireless communication device 102 according to some aspects. Wireless communication device 102 may include antenna system 202, transceiver 204, baseband modem 206 (including digital signal processor 208 and protocol controller 210), application processor 212, and memory 214. Although not explicitly shown in FIG. 2, in some aspects wireless communication device 102 may include one or more additional hardware and/or software components, such as processors/microprocessors, controllers/microcontrollers, other specialty or generic hardware/processors/circuits, peripheral device(s), memory, power supply, external device interface(s), subscriber identity module(s) (SIMs), user input/output devices (display(s), keypad(s), touchscreen(s), speaker(s), external button(s), camera(s), microphone(s), etc.), or other related components.

Wireless communication device 102 may transmit and receive radio signals on one or more radio access networks. Baseband modem 206 may direct this communication functionality of device 102 according to the communication protocols associated with each radio access network. Baseband modem 206 may thus control antenna system 202 and transceiver 204 to transmit and receive radio signals according to the formatting and scheduling parameters for the communication protocols. In some aspects where device 102 is configured to operate on multiple radio communication technologies, device 102 may include separate communication components for each supported radio communication technology (e.g., a separate antenna, RF transceiver, digital signal processor, and controller).

Device 102 may transmit and receive wireless signals with antenna system 202, which may be a single antenna or an antenna array that includes multiple antennas. In some aspects, antenna system 202 may additionally include analog antenna combination and/or beamforming circuitry. In the receive (RX) path, transceiver 204 may receive analog radio frequency signals from antenna system 202 and perform analog and digital RF front-end processing on the analog radio frequency signals to produce digital baseband samples (e.g., In-Phase/Quadrature (IQ) samples) for baseband modem 206. Transceiver 204 may include analog and digital reception components including amplifiers (e.g., Low Noise Amplifiers (LNAs)), filters, RF demodulators (e.g., RF IQ demodulators)), and analog-to-digital converters (ADCs), with which transceiver 204 may convert the received radio frequency signals to digital baseband samples. In the transmit (TX) path, transceiver 204 may receive digital baseband samples from baseband modem 206 and perform analog and digital RF front-end processing on the digital baseband samples to produce analog radio frequency signals for antenna system 202 to wirelessly transmit. Transceiver 204 may include analog and digital transmission components including amplifiers (e.g., Power Amplifiers (PAs), filters, RF modulators (e.g., RF IQ modulators), and digital-to-analog converters (DACs), which transceiver 204 may utilize to mix the digital baseband samples received from baseband modem 206 and produce the analog radio frequency signals for wireless transmission by antenna system 202. In some aspects baseband modem 206 may control the radio transmission and reception of transceiver 204. This may include specifying radio frequencies for transceiver 204 to transmit or receive on.

As shown in FIG. 2, baseband modem 206 may include digital signal processor 208, which may perform physical layer (PHY; Layer 1) transmission and reception processing. In the transmit path, digital signal processor 208 may prepare outgoing transmit data (from protocol controller 210) for transmission via transceiver 204. In the receive path, digital signal processor 208 may prepare incoming received data (from transceiver 204) for processing by protocol controller 210. Digital signal processor 208 may be configured to perform one or more of error detection, forward error correction encoding/decoding, channel coding and interleaving, channel modulation/demodulation, physical channel mapping, radio measurement and search, frequency and time synchronization, antenna diversity processing, power control and weighting, rate matching/de-matching, retransmission processing, interference cancelation, and any other physical layer processing functions. Digital signal processor 208 may be structurally realized as hardware components (e.g., as one or more digitally-configured hardware circuits or FPGAs), software-defined components (e.g., one or more processors configured to execute program code defining arithmetic, control, and I/O instructions (e.g., software and/or firmware) stored in a non-transitory computer-readable storage medium), or as a combination of hardware and software components. In some aspects, digital signal processor 208 may include one or more processors configured to retrieve and execute program code that defines control and processing logic for physical layer processing operations. In some aspects, digital signal processor 208 may execute processing functions with software via the execution of executable instructions. In some aspects, digital signal processor 208 may include one or more dedicated hardware circuits (e.g., ASICs, FPGAs, and other hardware) that are digitally configured to specific execute processing functions. The one or more processors of digital signal processor 208 may offload certain processing tasks to these dedicated hardware circuits, which are known as hardware accelerators. Exemplary hardware accelerators can include Fast Fourier Transform (FFT) circuits and encoder/decoder circuits. In some aspects, the processor and hardware accelerator components of digital signal processor 208 may be realized as a coupled integrated circuit.

Device 102 may be configured to operate according to one or more communication technologies. Digital signal processor 208 may be responsible for lower-layer processing functions (e.g., Layer 1/PHY) of the radio communication technologies, while protocol controller 210 may be responsible for upper-layer protocol stack functions (e.g., Data Link Layer/Layer 2 and/or Network Layer/Layer 3). Protocol controller 210 may thus be responsible for controlling the communication components of device 102 (antenna system 202, transceiver 204, and digital signal processor 208) according to the communication protocols of each supported radio communication technology. In some aspects, protocol controller 210 may represent the Access Stratum and Non-Access Stratum (NAS) (also encompassing Layer 2 and Layer 3) of each supported radio communication technology. Protocol controller 210 may be structurally embodied as a protocol processor configured to execute protocol stack software (retrieved from a controller memory) and subsequently control the radio communication components of device 102 to transmit and receive communication signals according to the protocol stack control logic in the protocol software. Protocol controller 210 may include one or more processors configured to retrieve and execute program code that defines the upper-layer protocol stack logic for one or more radio communication technologies, which can include Data Link Layer/Layer 2 and Network Layer/Layer 3 functions. Protocol controller 210 may be configured to perform both user-plane and control-plane functions to transfer application layer data to and from device 102 with the specific protocols of the supported radio communication technology. User-plane functions can include header compression and encapsulation, security, error checking and correction, channel multiplexing, scheduling and priority, while control-plane functions may include setup and maintenance of radio bearers. The program code retrieved and executed by protocol controller 210 may include executable instructions that define the logic of such functions.

Device 102 may also include application processor 212 and memory 214. Application processor 212 may be a CPU configured to handle the layers above the protocol stack, including the transport and application layers. Application processor 212 may be configured to execute various applications and/or programs of device 102 at an application layer of device 102. These applications and/or programs may include an operating system (OS), a user interface (UI) for supporting user interaction with device 102, and/or various user applications. The application processor may interface with baseband modem 206 and act as a source (in the transmit path) and a sink (in the receive path) for user data, such as voice data, audio/video/image data, messaging data, application data, basic Internet/web access data, etc. In the transmit path, protocol controller 210 may receive and process outgoing data provided by application processor 212 according to the layer-specific functions of the protocol stack, and provide the resulting data to digital signal processor 208. Digital signal processor 208 may then perform physical layer processing on the received data to produce digital baseband samples, which digital signal processor may provide to transceiver 204. Transceiver 204 may then process the digital baseband samples to convert the digital baseband samples to analog RF signals, which transceiver 204 may wirelessly transmit via antenna system 202. In the receive path, transceiver 204 may receive analog RF signals from antenna system 202 and process the analog RF signals to obtain digital baseband samples. Transceiver 204 may provide the digital baseband samples to digital signal processor 208, which may perform physical layer processing on the digital baseband samples. Digital signal processor 208 may then provide the resulting data to protocol controller 210, which may process the resulting data according to the layer-specific functions of the protocol stack and provide the resulting incoming data to application processor 212. Application processor 212 may then handle the incoming data at the application layer, which can include execution of one or more application programs with the data and/or presentation of the data to a user via a user interface.

Memory 214 may embody a memory component of device 102, such as a hard drive or another such permanent memory device. Although not explicitly depicted in FIG. 2, the various other components of device 102 shown in FIG. 2 may additionally each include integrated permanent and non-permanent memory components, such as for storing software program code, buffering data, etc.

Wi-Fi sensing in 2.4/5/60 GHz is typically performed by tracking the channel state of multiple Wi-Fi data packets over time. As a person or object moves around a given environment, it impacts how a Wi-Fi signal propagates from the transmitting STA to the receiving STA. A receiving STA participating in the transaction or a by-standing non-affiliated/associated STA may gather CSI from the over-the-air transmitted signal packets. The channel estimate is forwarded to a Wi-Fi sensing application. The more CSI available, the more accurate a Wi-Fi sensing application's prediction are. Wi-Fi sensing applications may include training a machine learning algorithm with CSI output. The machine learning algorithm may be trained to determine certains scenarios. For example, if an intruder has broken into a home for a home security system or determine that the number of people in a room has exceeded a maximum occupancy.

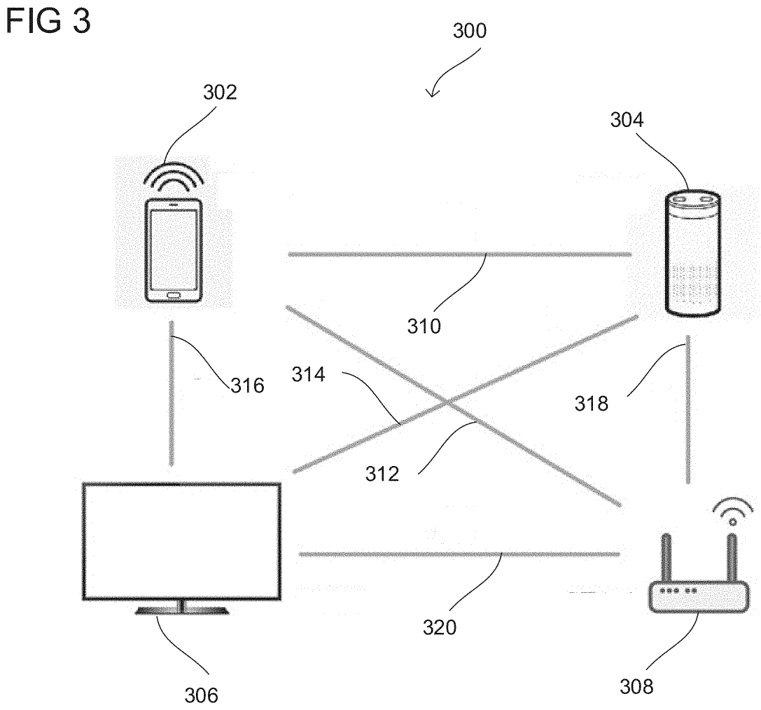

FIG. 3 shows Wi-Fi sensing system 300. Four STAs 302, 304, 306, and 308 are participating in Wi-Fi sensing. Any of the four STAs 302, 304, 306, or 308 may be capable of executing a Wi-Fi sensing application. If more STAs are part of the Wi-Fi sensing system, an STA may gather CSI regarding all channels between pairs of STAS to improve Wi-Fi sensing. As the four STAs communicate, the first STA 302 may gather CSI regarding channel 310 between first STA 302 and second STA 304, channel 312 between first STA 302 and fourth STA 308, and channel 316 between first STA 302 and third STA 306. Second STA 304 may gather CSI regarding channel 314 between second STA 304 and third STA 306 and channel 318 between second STA 304 and fourth STA 308. Third STA 306 may gather CSI regarding channel 320 between third STA 306 and fourth STA 308. It should be noted that any STA can gather CSI between itself and any other STA.

Wi-Fi sensing applications require CSI to accurately make predictions. There may be several methods of gathering CSI. For example, gathering CSI using Wi-Fi network traffic between STAs. For example, some Wi-Fi sensing systems may gather CSI of frames of Wi-Fi transmissions between two or more STAs. Alternatively, some Wi-Fi sensing systems may gather CSI using periodic beacon frames transmitted from an access point (AP) to STAs. These approaches are built on existing Wi-Fi infrastructure and are seamless to the communication protocol without requiring additional Wi-Fi transmissions for the purpose of sensing.

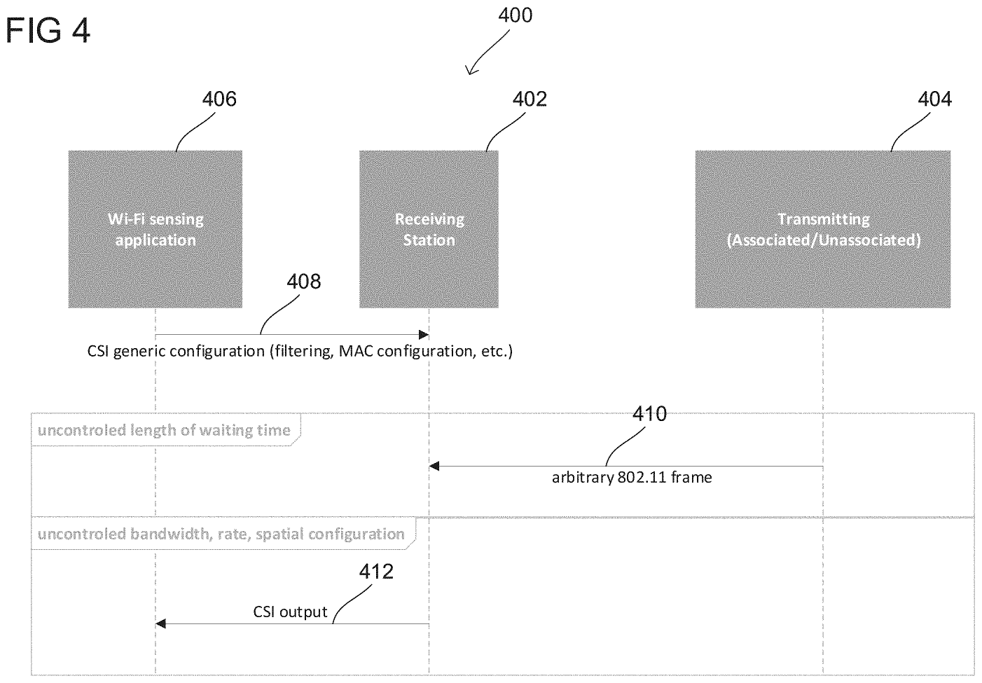

FIG. 4 shows a Wi-Fi network 400 configured to gather CSI using network traffic. Receiving STA 402 may participate in Wi-Fi sensing and receive Wi-Fi sensing CSI configuration parameters 408 from Wi-Fi sensing application 406. For example, the configuration parameters may include Wi-Fi packet periodicity and bandwidth, among others. An application for detecting a sudden movement in a sport activity may require different CSI measurements or configuration parameters as compared to a presence detection algorithm. Receiving STA 402 may gather CSI in accordance with CSI configuration parameters 408. Receiving STA 402 gathers CSI based on data packet 410 from transmitting STA 404. The CSI 412 is sent to Wi-Fi sensing application 406. Wi-Fi sensing application 406 may include a machine learning algorithm to aid in Wi-Fi sensing. Gathering CSI based on data packets is dependent on Wi-Fi network traffic. If Wi-Fi network traffic is scarce, Wi-Fi sensing application 406 may not have enough CSI data to make accurate predictions.

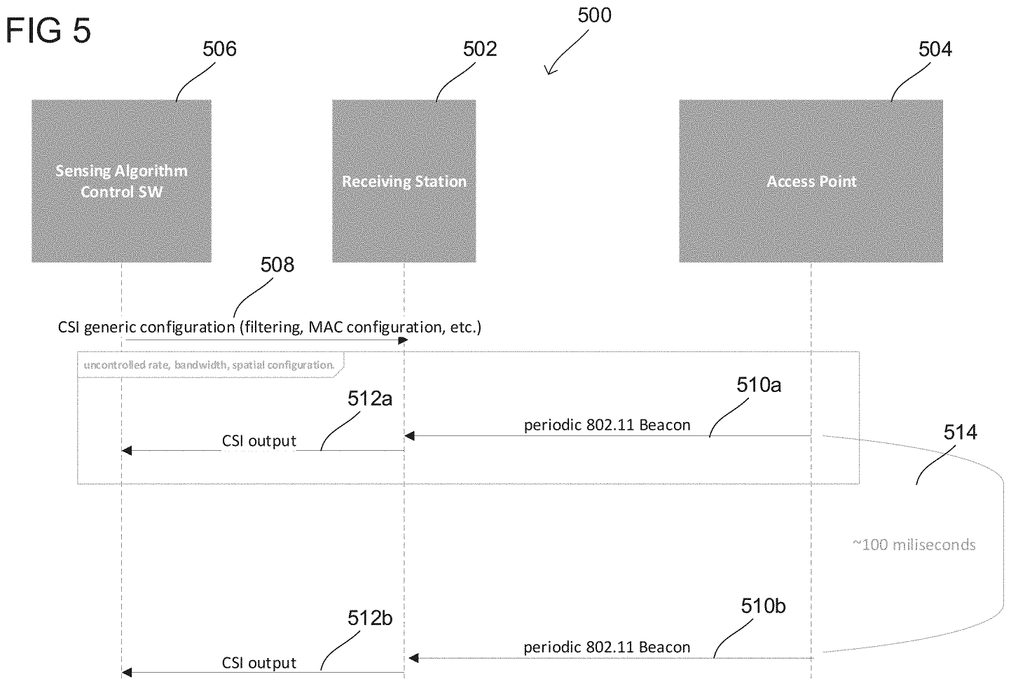

FIG. 5 shows a Wi-Fi network 500 configured to gather CSI using beacon frames. Receiving STA 502 may participate in Wi-Fi sensing and receive Wi-Fi sensing CSI configuration parameters 508 from Wi-Fi sensing application 506. Receiving STA 502 may gather CSI in accordance with CSI configuration parameters 508. Receiving STA 502 gathers CSI based on beacon frames 510a and 510b from AP 504. CSI output 512a and 512b are based on beacon frames 510a and 510b respectively. CSI output 512a and 512b are sent to Wi-Fi sensing application 506. Wi-Fi sensing application 506 may include a machine learning algorithm to aid in Wi-Fi sensing. Gathering CSI based on beacon frames. Beacon frames 510a and 510b are transmitted at a low rate and narrow bandwidth and include less subcarriers as compared to data packet 410. Additionally, beacon frames are transmitted in a single spatial stream and their transmission interval 514 are nominally 100 ms reducing their efficacy for Wi-Fi sensing application 506.

Gathering CSI without requiring existing Wi-Fi network traffic and enhanced information over a low modulation 100 ms interval Beacon frame may improve Wi-Fi sensing applications. Sensing applications range from detecting movement sensing, counting people, and medical applications such as breathing rate, heartbeat, sleep state tracking, presence, and fall detection, etc.

CSI analysis in support of sensing a physical environment may require periodic CSI captures of a physical channel in 0.1-2000 millisecond range intervals. This requirement becomes crucial when sensing small movements such as human breathing rate, heart rate, and other subtle or fast human body movements. Inducing traffic for the sake of gathering CSI on may not be desirable, or in some cases not possible because by the STA performing CSI based sensing. Gathering CSI based on beacon frames may lack valuable properties to produce high enough quality CSI output because beacon frames utilize a single spatial stream and are transmitted with the lowest basic rate possible. For example, the base station subsystem (BSS) may transmit beacon frames in a narrow bandwidth of 20 MHz.

Sending request messages to trigger a response message for CSI gathering reduces the dependency on existing Wi-Fi network activity. The request messages can be configured to trigger response messages with valuable properties, such as a large number of subcarriers, to produce high quality CSI output.

Additionally, the STA gathering CSI can regulate the flow of ‘radio snapshots’ it initiates according to upper layer's sensing algorithm requirements, reducing the amount of CSI collection “noise” and providing the upper layers with just enough CSI that is customized to the sensing algorithm's requirements.

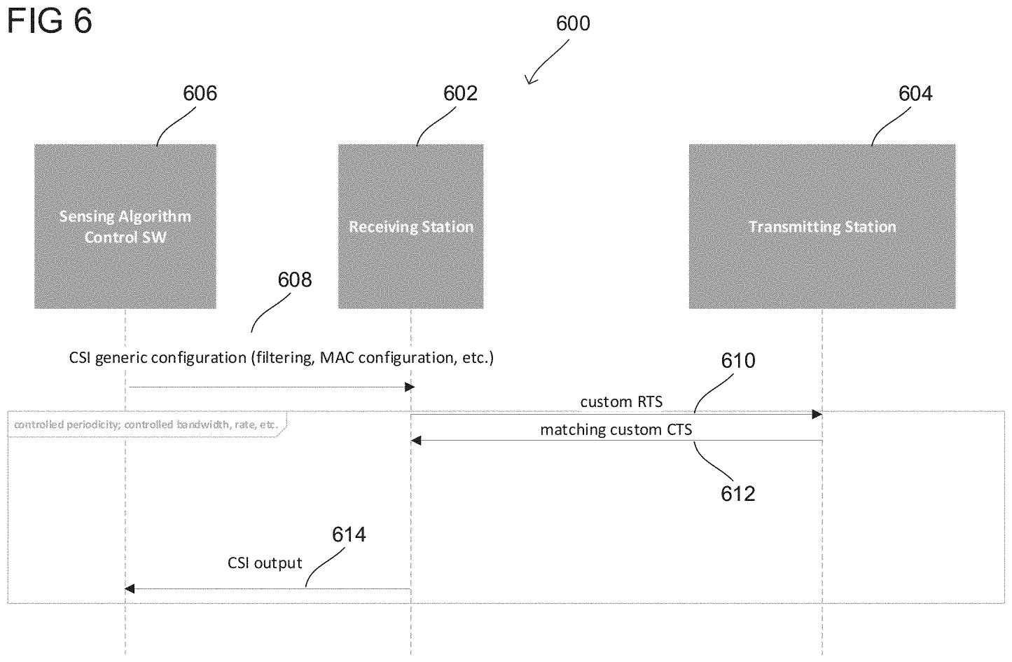

FIG. 6 shows a Wi-Fi network 600 configured to gather CSI using control packets. Receiving STA 602 may participate in Wi-Fi sensing and receive Wi-Fi sensing CSI configuration parameters 608 from Wi-Fi sensing application 606. Receiving STA 602 may gather CSI in accordance with CSI configuration parameters 608. Receiving STA 602 may generate a custom request-to-send (RTS) frame 610 based on the configuration parameters 608. Receiving station 602 may send RTS 610 to transmitting station 604. RTS 610 triggers transmitting station 604 to transmit clear-to-send (CTS) frame 612. CTS 612 matches the configuration of RTS 610. For example, if RTS is sent with a high rate, CTS uses the same rate in response. Receiving STA 602 gathers CSI based on CTS 612 from transmitting STA 604. CSI output 614 is sent to Wi-Fi sensing application 606. Wi-Fi sensing application 606 may include a machine learning algorithm to aid in Wi-Fi sensing.

An exchange of request-to-send (RTS) and clear-to-send (CTS) frames is initiated by a receiving station (the Wi-Fi device gathering CSI). The receiving station sends a custom configured RTS in several bandwidth parts concurrently or simultaneously (dup mode) and receives back the CTS from the transmitting STA (the Wi-Fi device sending the CTS in response to the RTS). The CTS is received in several bandwidth parts matching the bandwidth parts used to send the RTS. The receiving STA extracts CSI from the incoming CTS frame.

The RTS may be configured to use a high rate, large bandwidth dup mode, and/or a number of spatial streams. Ideally the CTS will be answered in the same rate as the RTS was sent. Allowing flexibility by the CSI gathering STA to decide what kind of channel it selects to capture.

By incorporating RTS/CTS mechanisms of 802.11 mac, a receiving station may initiate a CSI gathering session by transmitting an RTS frame with the required bandwidth and rate. The required bandwidth and rate may be decided upon by upper layers of the sensing algorithm. An 802.11 device is obliged to respond with a proper matching CTS (matching in rate & bandwidth) on top of which the receiving station will collect CSI. Furthermore, the receiving STA may utilize more than one spatial stream for sending the RTS to a capable transmitting STA and expect to receive a multiple spatial stream CTS in return. If the CTS uses a single spatial stream, the station may open more than one receive chain thus utilizing multiple-receive-chain-mode (MRC) and enlarge the amount of CSI data further.

A requirement of the RTS/CTS is that the receiving and transmitting STAs must be associated. For example, if a Wi-Fi device must be associated with an AP to receive a CTS frame from the AP, otherwise sending an RTS may cause an 802.11 specification violation.

However, probe request and response frames do not require that the receiving STA and the transmitting STA are associated.

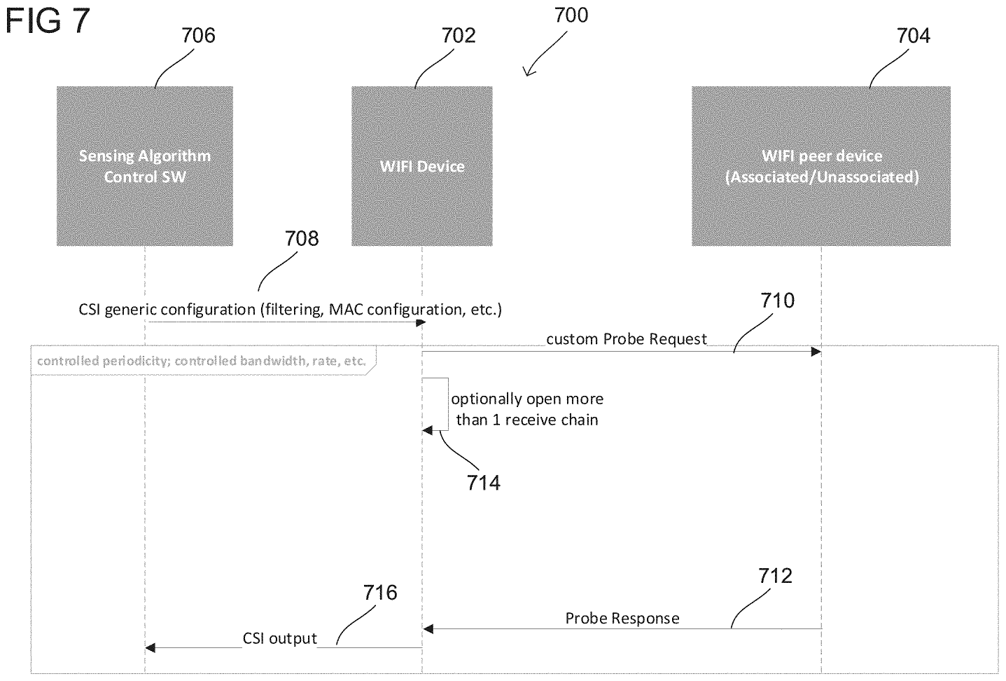

FIG. 7 shows a Wi-Fi network 700 configured to gather CSI using probe requests and responses. Receiving STA 702 may participate in Wi-Fi sensing and receive Wi-Fi sensing CSI configuration parameters 708 from Wi-Fi sensing application 706. Receiving STA 702 may gather CSI in accordance with CSI configuration parameters 708. Receiving STA 702 may generate a custom probe request 710 based on the configuration parameters 708. Receiving station 702 may send probe request 710 to transmitting station 704. Probe request 710 triggers transmitting station 704 to transmit probe response 712. Probe response 712 may not match the configuration of probe request 710. Receiving STA 702 may open multiple receive chains 714 to receive probe response 712. Receiving STA 702 gathers CSI based on probe response 712 from transmitting STA 704. CSI output 716 is sent to Wi-Fi sensing application 706. Wi-Fi sensing application 706 may include a machine learning algorithm to aid in Wi-Fi sensing.

Using the 802.11 probe request/respond scheme may cause a transmitting STA to transmit a probe response in response to a custom probe request frame. The receiving STA and transmitting STA do not need to be associated. An unassociated STA may send a custom probe request packet and gather collect CSI upon the probe response packet.

Probe responses may not respond with the same rate, bandwidth, and spatial configuration as the probe request. Future methods may include a standard that will require that probe responses are configured with the same parameters as the probe request. Probe responses which match the probe request will support improved CSI gathering at the receiving STA.

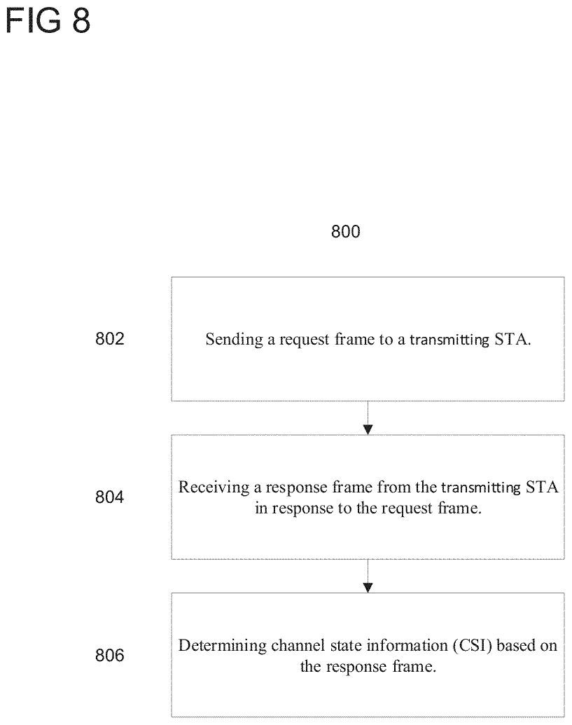

FIG. 8 shows an exemplary method of performing channel estimation using control or management packets. FIG. 8 shows exemplary method 800. As shown in FIG. 8, method 800 includes sending a request frame to a transmitting STA (stage 802); receiving a response frame from the transmitting STA in response to the request frame (stage 804); and determining channel state information (CSI) based on the response frame (stage 806).

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

While the above descriptions and connected figures may depict electronic device components as separate elements, skilled persons will appreciate the various possibilities to combine or integrate discrete elements into a single element. Such may include combining two or more circuits for form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

The following examples disclose various aspects of this disclosure:

In Example 1, an apparatus of a Wi-Fi station (STA), the apparatus including a radio frequency (RF) interface, and one or more processors coupled to the RF interface configured to: send a request frame to a transmitting STA; receive a response frame from the transmitting STA in response to the request frame; and determine channel state information (CSI) based on the response frame.

In Example 2, the subject matter of Example 1, may optionally further include a transceiver configured to transmit and receive wireless signals.

In Example 3, the subject matter of any one of Examples 1 or 2, may optionally further include one or more antennas coupled to the transceiver to cause to send the request frame.

In Example 4, the subject matter of any one of Examples 1 to 3, may optionally further include wherein the request frame is a request to send (RTS) frame and the response frame is a clear to send (CTS) frame.

In Example 5, the subject matter of any one of Examples 1 to 4, may optionally further include wherein the RTS frame is sent over several bandwidth parts in a duplicate mode.

In Example 6, the subject matter of any one of Examples 1 to 5, may optionally further include wherein the CTS frame is received over several bandwidth parts in a duplicate mode.

In Example 7, the subject matter of any one of Examples 1 to 6, may optionally further include wherein the RTS frame uses a high data transmission rate over a plurality of spatial streams.

In Example 8, the subject matter of any one of Examples 1 to 7, may optionally further include wherein the CTS frame uses a high data transmission rate over a plurality over a number of spatial streams.

In Example 9, the subject matter of any one of Examples 1 to 8, may optionally further include wherein the request frame is a request probe frame and the response frame is a response probe frame.

In Example 10, the subject matter of any one of Examples 1 to 9, may optionally further include wherein the request frame is sent in accordance with a data rate requirement and a bandwidth requirement.

In Example 11, the subject matter of any one of Examples 1 to 10, may optionally further include wherein the request frame is sent at an interval.

In Example 12, the subject matter of any one of Examples 1 to 11, may optionally further include wherein the interval is between 1 and 100 milliseconds.

In Example 13, a method for determining channel state information (CSI) including sending a request frame to a transmitting STA; receiving a response frame from the transmitting STA in response to the request frame; and determining channel state information (CSI) based on the response frame.

In Example 14, the subject matter of Example 14, may optionally further include 14 generating a wireless signal based on the request frame.

In Example 15, the subject matter of any one of Examples 13 or 14, may optionally further include transmitting the wireless signal.

In Example 16, the subject matter of any one of Examples 13 to 15, may optionally further include wherein the request frame is a request to send (RTS) frame and the response frame is a clear to send (CTS) frame.

In Example 17, the subject matter of any one of Examples 13 to 16, may optionally further include wherein the CTS frame is received over several bandwidth parts in a duplicate mode.

In Example 18, the subject matter of any one of Examples 13 to 17, may optionally further include wherein the CTS frame is received over several bandwidth parts in a duplicate mode.

In Example 19, the subject matter of any one of Examples 13 to 18, may optionally further include wherein the RTS frame uses a high data transmission rate over a plurality of spatial streams.

In Example 20, the subject matter of any one of Examples 13 to 19, may optionally further include wherein the CTS frame uses a high data transmission rate over a plurality over a number of spatial streams.

In Example 21, the subject matter of any one of Examples 13 to 20, may optionally further include wherein the request frame is a request probe frame and the response frame is a response probe frame.

In Example 22, the subject matter of any one of Examples 13 to 21, may optionally further include wherein the request frame is sent in accordance with a data rate requirement and a bandwidth requirement.

In Example 23, the subject matter of any one of Examples 13 to 22, may optionally further include wherein the request frame is sent at an interval.

In Example 24, the subject matter of any one of Examples 13 to 23, may optionally further include wherein the interval is between 1 and 100 milliseconds.

In Example 25, one or more non-transitory computer readable media comprising programmable instructions thereon, that when executed by one or more processors of a device, cause the device to perform any one of the methods of claims 13 to 24.

In Example 26, a system comprising one or more devices according to any of claims 1 to 12, the system configured to implement a method according to any of claims 13 to 24.

In Example 27, a means for implementing any of the claims 1 to 12.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. An apparatus of a Wi-Fi station (STA), the apparatus including a radio frequency (RF) interface, and one or more processors coupled to the RF interface configured to:
send a request frame over a transmitting channel;
receive a response frame over the transmitting channel in response to the request frame; and
determine channel state information (CSI) based on the response frame.

2. The apparatus of claim 1, further comprising a transceiver configured to transmit the request frame and receive the response frame over the transmitting channel.

3. The apparatus of claim 2, further comprising one or more antennas coupled to the transceiver to cause to send the request frame.

4. The apparatus of claim 1, wherein the request frame is a request to send (RTS) frame and the response frame is a clear to send (CTS) frame.

5. The apparatus of claim 4, wherein the RTS frame is sent over several bandwidth parts in a duplicate mode.

6. The apparatus of claim 4, wherein the CTS frame is received over several bandwidth parts in a duplicate mode.

7. The apparatus of claim 5, wherein the RTS frame uses a high data transmission rate over a plurality of spatial streams.

8. The apparatus of claim 6, wherein the CTS frame uses a high data transmission rate over a plurality over a number of spatial streams.

9. The apparatus of claim 1, wherein the request frame is a request probe frame and the response frame is a response probe frame.

10. The apparatus of claim 1, wherein the request frame is sent in accordance with a data rate requirement and a bandwidth requirement.

11. The apparatus of claim 1, wherein the request frame is sent at an interval.

12. The apparatus of claim 11, wherein the interval is between 1 and 100 milliseconds.

13. A method for determining channel state information (CSI) comprising:
sending a request frame to a transmitting STA;
receiving a response frame from the transmitting STA in response to the request frame; and
determining channel state information (CSI) based on the response frame.

14. The method of claim 13, further comprising generating a wireless signal based on the request frame.

15. The method of claim 14, further comprising transmitting the wireless signal.

16. The method of claim 13, wherein the request frame is a request to send (RTS) frame and the response frame is a clear to send (CTS) frame.

17. The method of claim 16, wherein the RTS frame is sent over several bandwidth parts in a duplicate mode.

18. The method of claim 16, wherein the CTS frame is received over several bandwidth parts in a duplicate mode.

19. The method of claim 17, wherein the RTS frame uses a high data transmission rate over a plurality of spatial streams.

20. The method of claim 18, wherein the CTS frame uses a high data transmission rate over a plurality over a number of spatial streams.
